(19) United States
(12) Patent Application Publication
(10) Pub. No.: US 2025/0192481 A1
(43) Pub. Date: Jun. 12, 2025

(54) SHIELD CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Hiroya TANAKA, Mie (JP); Junichi MUKUNO, Mie (JP); Jaeyeon KIM, Mie (JP); Yuta KANEMATSU, Mie (JP); Sunghyun BYUN, Mie (JP)

(21) Appl. No.: 18/845,893

(22) PCT Filed: Mar. 3, 2023
(86) PCT No.: PCT/JP2023/008019

§ 371 Date: Sep. 11, 2024

(30) Foreign Application Priority Data
Mar. 14, 2022 (JP) 2022-039431

(51) Int. Cl. H01R 13/6581

(52) U.S. Cl. CPC H01R 13/6581

(57) ABSTRACT

A shield connector of a novel structure is disclosed which can stably exhibit desired heat dissipation performance in a shorter heat dissipation path by suppressing a reduction in heat dissipation performance due to an ambient temperature change. A shield connector includes a terminal fitting including a terminal connecting portion to be connected to a mating terminal, an insulating housing for accommodating the terminal fitting, a shield shell for covering an outer surface of the housing, a heat transfer portion for transferring heat of the terminal connecting portion to the shield shell by being interposed between the terminal connecting portion and the shield shell, and a spring member integrally provided to the terminal fitting. The terminal connecting portion is pressed into contact with the shield shell via the heat transfer portion by a resilient force of the spring member.

### TECHNICAL FIELD

The present disclosure relates to a shield connector.

### BACKGROUND

Patent Document 1 discloses a shield connector provided with a terminal fitting including a terminal connecting portion to be connected to a mating terminal, a wire connected to a wire connecting portion of the terminal fitting and a shield shell made of metal for covering the wire connecting portion of the terminal fitting and the wire, the wire connecting portion and the shield shell being integrated by an insert-molded insulating resin portion. In this shield connector, the wire connecting portion of the terminal fitting is integrated with the shield shell by being closely covered by the insulating resin portion filled to fill up an air layer in the shield shell by insert molding. Thus, heat generated in an electrically conductive path is quickly transferred from the insulating resin portion to the shield shell made of metal without via the air layer and dissipated, wherefore the heat dissipation of the shield connector can be improved.

### PRIOR ART DOCUMENT

### Patent Document

Patent Document 1: JP 2018-113119 A

### SUMMARY OF THE INVENTION

### Problems to be Solved

In the shield connector described in Patent Document 1, there is a possibility of reducing desired heat dissipation performance if short shots or voids (gaps) occur due to resin fluidity at the time of molding the insulating resin portion. Further, since the insulating resin portion and the shield connector and the terminal fitting made of metal have different linear expansion coefficients, there is also a possibility of reducing heat dissipation performance due to the generation of an air layer (gap) between contact surfaces of the insulating resin portion and the shield connector and the terminal fitting made of metal caused by an ambient temperature change during use. Further, since a part of the terminal fitting to be contacted by the insulating resin portion is the wire connecting portion, there has been also an inherent problem that a distance from the terminal connecting portion where heat is generated most in the electrically conductive path to the shield shell, which is a heat dissipating part, is long and thermal resistance is large.

Accordingly, a shield connector of a novel structure is disclosed which can stably exhibit desired heat dissipation performance in a shorter heat dissipation path by suppressing a reduction in heat dissipation performance due to an ambient temperature change.

### Means to Solve the Problem

The present disclosure is directed to a shield connector with a terminal fitting including a terminal connecting portion to be connected to a mating terminal, an insulating housing for accommodating the terminal fitting, a shield shell for covering an outer surface of the housing, a heat transfer portion for transferring heat of the terminal connecting portion to the shield shell by being interposed between the terminal connecting portion and the shield shell, and a spring member integrally provided to the terminal fitting, the terminal connecting portion being pressed into contact with the shield shell via the heat transfer portion by a resilient force of the spring member.

### Effect of the Invention

According to a shield connector of the present disclosure, desired heat dissipation performance can be stably exhibited in a shorter heat dissipation path by suppressing a reduction in heat dissipation performance due to an ambient temperature change.

### BRIEF DESCRIPTION OF THE DRAWINGS

FIG. 1 is a perspective view of a shield connector according to a first embodiment.

FIG. 2 is a side view of the shield connector shown in FIG. 1.

FIG. 3 is a section along III-III in FIG. 2.

FIG. 4 is an exploded perspective view of the shield connector shown in FIG. 1.

FIG. 5 is a perspective view showing a terminal side assembly constituting the shield connector shown in FIG. 1 when viewed from above.

FIG. 6 is a perspective view showing the terminal side assembly shown in FIG. 5 when viewed from below.

FIG. 7 is a perspective view showing a shell side assembly constituting the shield connector shown in FIG. 1.

FIG. 8 is a section along VIII-VIII in FIG. 7.

FIG. 9 is a perspective view showing a housing constituting the shield connector shown in FIG. 1.

FIG. 10 is a section, corresponding to FIG. 3, showing a state where a mating terminal is connected to the shield connector shown in FIG. 1.

FIG. 11 is a longitudinal section, corresponding to FIG. 3, showing a shield connector according to a second embodiment.

FIG. 12 is a perspective view showing a terminal side assembly constituting the shield connector shown in FIG. 11 when viewed from above.

### DETAILED DESCRIPTION TO EXECUTE THE INVENTION

### Description of Embodiments of Present Disclosure

First, embodiments of the present disclosure are listed and described.

(1) The shield connector of the present disclosure is provided with a terminal fitting including a terminal connecting portion to be connected to a mating terminal, an insulating housing for accommodating the terminal fitting, a shield shell for covering an outer surface of the housing, a heat transfer portion for transferring heat of the terminal connecting portion to the shield shell by being interposed between the terminal connecting portion and the shield shell, and a spring member integrally provided to the terminal fitting, the terminal connecting portion being pressed into contact with the shield shell via the heat transfer portion by a resilient force of the spring member.

According to the shield connector of the present disclosure, instead of the insulating resin portion molded to fill a gap between the shield shell and the terminal fitting in the conventional structure, the terminal connecting portion, which is a heat generating part of the terminal fitting, is held in contact with the shield shell via the heat transfer portion interposed between the terminal connecting portion and the shield shell and this state can be held by a resilient force of the spring member. That is, the terminal connecting portion, which is the heat generating part, is pressed and held in contact with the shield shell via the heat transfer portion using the resilient force of the spring member, instead of the insulating resin portion molded in a heat dissipation path. In this way, the terminal connecting portion can be stably held in contact with the shield shell via the heat transfer portion, utilizing the resilient force of the spring member. In addition, since a part of the terminal fitting to be contacted by the heat dissipation member is the terminal connecting portion, the terminal connecting portion generating heat most in an electrically conductive path can be directly brought into contact with the shield shell via the heat dissipation member. As a result, the heat dissipation path can be made shorter and desired heat dissipation performance can be stably exhibited as compared to the conventional structure.

Further, since the spring member is integrally provided to the terminal fitting, the number of components can be reduced and assembly workability can be improved.

Note that the heat transfer portion desirably has a higher thermal conductivity than the housing and can be constituted by a wall portion of the housing or another member having a higher thermal conductivity than the housing.

Further, an arbitrary shape can be adopted for the terminal fitting integrally including the spring member if the terminal connecting portion can be pressed into contact with the shield shell via the heat transfer portion by the resilient force of the spring member.

(2) Preferably, the heat transfer portion includes a heat dissipation member made of an insulating material having a higher thermal conductivity than the housing, and the heat dissipation member has a connecting portion side contact surface to be held in contact with the terminal connecting portion and a shell side contact surface to be held in contact with the shield shell by being exposed from the housing. This is because the connecting portion side contact surface and the shell side contact surface of the heat dissipation member made of the insulating material having a higher thermal conductivity than the housing can respectively contact the terminal connecting portion and the shield shell, heat of the terminal connecting portion can be efficiently transferred and excellent heat dissipation performance can be ensured. Note that an arbitrary shape can be adopted for the heat dissipation member if the shell side contact surface of the heat dissipation member can be pressed against the shield shell by the resilient force of the spring member transferred to the connecting portion side contact surface.

(3) Preferably, the terminal connecting portion of the terminal fitting has a rectangular tube shape, a mating terminal arrangement portion is formed inside the terminal connecting portion, the mating terminal being inserted into the mating terminal arrangement portion, and a holding portion for holding the integrally provided spring member is formed by one of a pair of facing wall portions of the terminal connecting portion, a contact surface is formed by the other of the pair of facing wall portions, and the contact surface is pressed into contact with the heat transfer portion. Since the terminal connecting portion of the terminal fitting has the rectangular tube shape, the mating terminal arrangement portion can be provided inside the terminal connecting portion and a risk that the mating terminal arrangement portion and the mating terminal interfere with the spring member can be eliminated or reduced. Particularly, if a resilient contact piece or the like to be brought into resilient contact with the mating terminal projects in the mating terminal arrangement portion, the deformation of the resilient contact piece is hindered and a desired contact state with the mating terminal can be advantageously maintained. Moreover, since the holding portion for holding the integrally provided spring member and the contact surface to be held in contact with the heat transfer portion are formed, utilizing the pair of facing wall portions of the terminal connecting portion having the rectangular tube shape, a degree of freedom in designing the spring member can be improved and the terminal connecting portion can be pressed against the connecting portion side contact surface of the heat dissipation member over a wide contact area. As a result, heat dissipation from the terminal connecting portion to the shield shell can be more stably realized.

(4) Preferably, the spring member is constituted by a flat plate portion separated and inclined from the holding portion and projecting toward a base end side of the terminal connecting portion via a curved portion provided on a tip part of the holding portion of the terminal connecting portion, and the spring member is resiliently deformed in a direction toward the terminal connecting portion with the terminal fitting accommodated in the housing. The spring member can be integrally provided to the holding portion of the terminal connecting portion having the rectangular tube shape by a simple structure, and manufacturability can be improved.

(5) Preferably, the terminal connecting portion of the terminal fitting has a flat plate shape, the spring member is constituted by a flat plate portion separated and inclined from the terminal connecting portion and projecting toward a base end side of the terminal connecting portion via a curved portion provided on a tip part of the terminal connecting portion, and the spring member is resiliently deformed in a direction toward the terminal connecting portion with the terminal fitting accommodated in the housing. Since the resilient connecting portion and the spring member can be integrally formed by two flat plate-like portions coupled via the curved portion, the terminal connecting portion and the shield connector itself can be reduced in size.

### Details of Embodiments of Present Disclosure

Specific examples of a shield connector of the present disclosure are described below with reference to the drawings. Note that the present disclosure is not limited to these illustrations, but is represented by claims and intended to include all changes in the scope of claims and in the meaning and scope of equivalents.

### First Embodiment

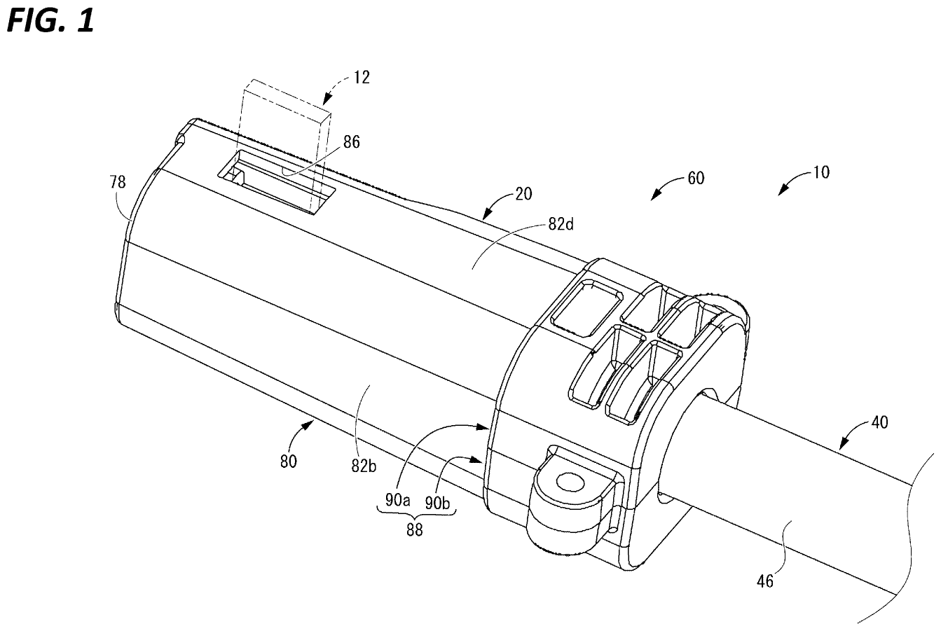

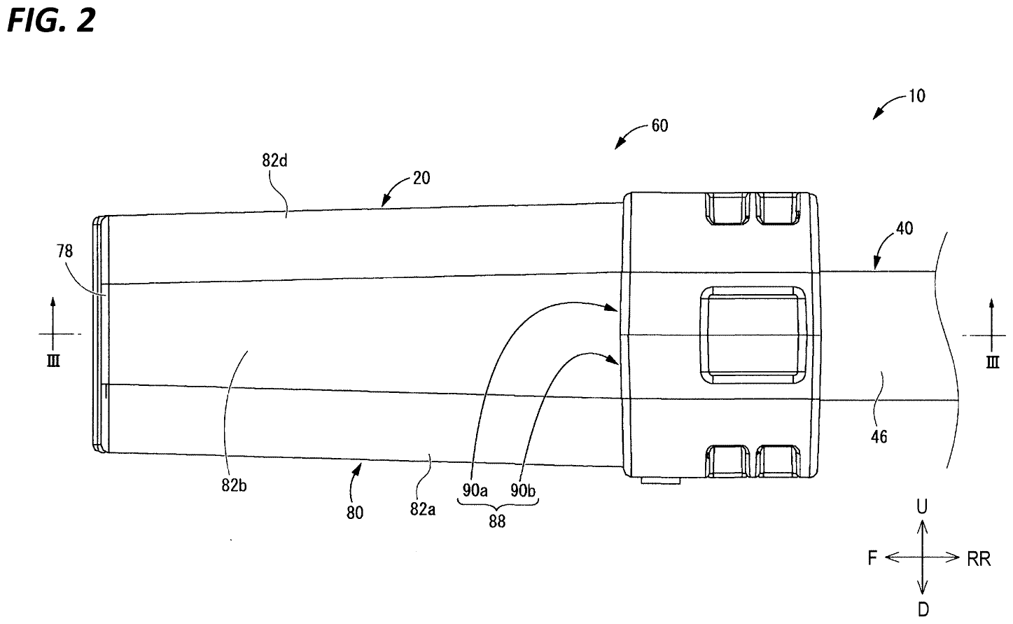

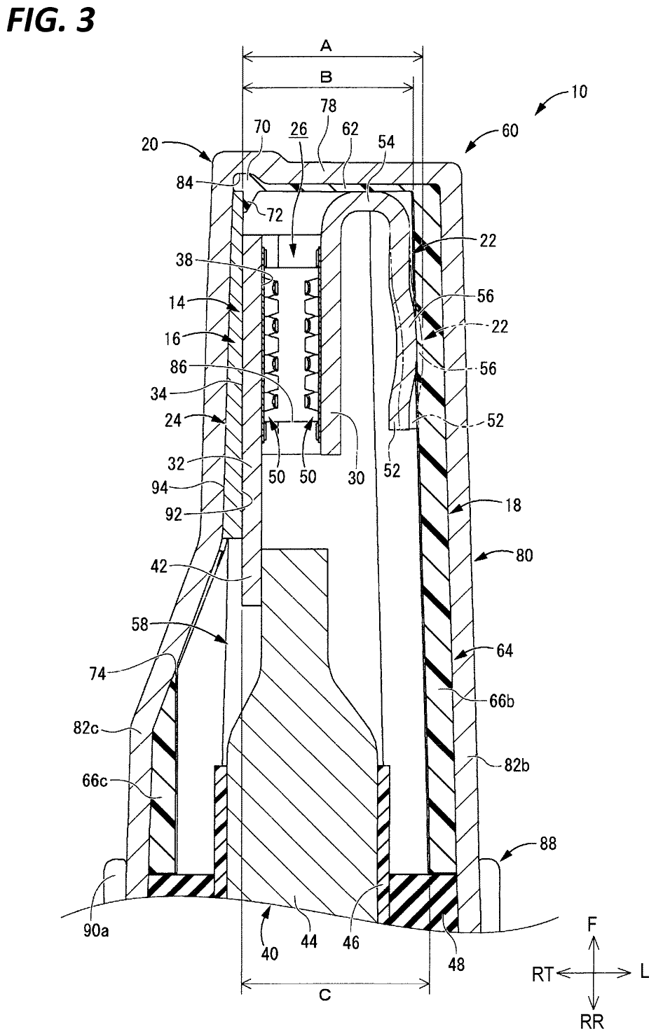

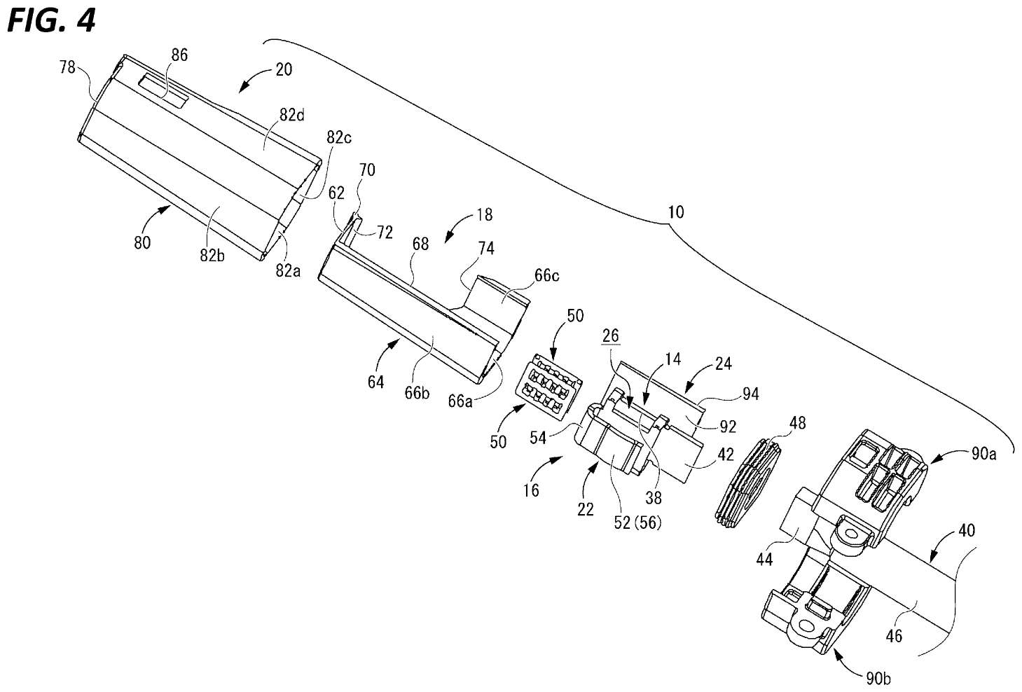

Hereinafter, a shield connector 10 of a first embodiment of the present disclosure is described with reference to FIGS. 1 to 10. This shield connector 10 is, for example, applied to an electric vehicle or a hybrid vehicle, and used in a large current region of a high-voltage connector from a PCU (power control unit) to a battery. Note that the shield connector 10 can be arranged in an arbitrary orientation, but an upper side is an upper side in FIG. 2, a lower side is a lower side in FIG. 2, a front side is a left side in FIG. 2, a rear side is a right side in FIG. 2, a left side is a front side in a direction orthogonal to the plane of FIG. 2 (right side in FIG. 3), and a right side is a back side in the direction orthogonal to the plane of FIG. 2 (left side in FIG. 3). Further, for a plurality of identical members, only some members may be denoted by a reference sign and the other members may not be denoted by the reference sign.

### (Shield Connector 10)

The shield connector 10 is provided with a terminal fitting 16 including a terminal connecting portion 14 to be connected to a mating terminal 12, an insulating housing 18 for accommodating the terminal fitting 16 and a shield shell 20 for covering the outer surface of the housing 18. Further, a spring member 22 is integrally provided to the terminal fitting 16. A heat transfer portion for transferring heat of the terminal connecting portion 14 to the shield shell 20 is provided between the terminal connecting portion 14 and the shield shell 20. In the first embodiment, the heat transfer portion is configured to include a heat dissipation member 24 made of an insulating material having a higher thermal conductivity than the housing 18.

### (Mating Terminal 12)

The shape of the mating terminal 12 is not limited, but in the form of a substantially flat tab in the first embodiment. Note that, in the first embodiment, a mating terminal arrangement portion 26 is provided inside the terminal connecting portion 14 as described later and the mating terminal 12 is inserted into a mating terminal insertion hole 86 provided in the shield shell 20. The mating terminal 12 arranged in the mating terminal arrangement portion 26 and the terminal connecting portion 14 of the terminal fitting 16 accommodated in the housing 18 contact and are conductively connected. That is, in the first embodiment, the mating terminal 12 is a male terminal and the terminal connecting portion 14 is a female terminal.

### (Terminal Fitting 16)

As also shown in FIGS. 3 to 6, the shield connector 10 includes the terminal fitting 16 integrally provided with the spring member 22. This terminal fitting 16 is formed, for example, by bending a metal flat plate having a predetermined shape into a shape as described below.

The terminal connecting portion 14 in the terminal fitting 16 has a substantially rectangular tube shape extending in a front-rear direction and is open on both sides in the front-rear direction in the shield connector 10. That is, the terminal connecting portion 14 includes a lower wall portion 28 constituting a wall portion on a lower side, a left wall portion 30 as one of a pair of facing wall portions projecting upward from both lateral sides of the lower wall portion 28, and a right wall portion 32 as the other of the pair of facing wall portions. Note that, as described later, the outer surface (right end surface) of the right wall portion 32 is a contact surface 34 to be held in contact with a connecting portion side contact surface 92 in the heat dissipation member 24. Further, a lateral central part of a front end part of the lower wall portion 28 is cut to provide a positioning recess 36 open forward and penetrating in a thickness direction (vertical direction).

Upper end parts of these left and right wall portions 30, 32 are coupled in both end parts in the front-rear direction, thereby configuring the terminal connecting portion 14 having the substantially rectangular tube shape. Further, the left and right wall portions 30, 32 are not coupled in an intermediate part in the front-rear direction of an upper end part of the terminal connecting portion 14, thereby providing an upper opening 38 open upward. As a result, the mating terminal arrangement portion 26, which is an internal space of the terminal connecting portion 14, and an outside space communicate with each other through the upper opening 38.

In such a terminal connecting portion 14, the upper end parts of the left and right wall portions 30, 32 can be coupled, for example, by crimping. Further, in the terminal fitting 16, the right wall portion 32 extends further rearward than the left wall portion 30, and a wire 40 is fixed and connected to a rear end part of the right wall portion 32 extending further rearward than the left wall portion 30. That is, the rear end part of the right wall portion 32 is a wire connecting portion 42, and the terminal connecting portion 14 is provided in a front part and the rear end part serves as the wire connecting portion 42 in the terminal fitting 16.

The wire 40 is a coated wire, and an insulation coating 46 made of synthetic resin is externally fit to a core wire 44. The insulation coating 46 is stripped in a tip part of the wire 40 to expose the core wire 44, and the wire 40 and the terminal fitting 16 are conductively connected by fixing the exposed core wire 44 to the rear end part (wire connecting portion 44) of the terminal fitting 16 by crimping, welding or the like. Note that an annular waterproof rubber 48 having a substantially rectangular outer shape is externally mounted on a part of the wire 40 behind the exposed core wire 44.

In the terminal connecting portion 14, terminal spring portions 50 are provided on the facing inner surfaces of the left and right wall portions 30, 32. The terminal spring portions 50 are substantially in the form of rectangular plates as a whole, made of metal good in electrical conductivity and fixed to the respective inner surfaces of the left and right wall portions 30, 32. In the terminal spring portion 50, parts raised into a substantially chevron shape project laterally inward, i.e. toward the inside of the mating terminal arrangement portion 26. A plurality of the parts raised into the substantially chevron shape are provided and aligned and arranged in the vertical direction and front-rear direction. When the mating terminal 12 is inserted and arranged in the mating terminal arrangement portion 26 as described later, the substantially chevron-shaped projecting parts of the terminal spring portions 50 are pressed by the mating terminal 12 and resiliently deformed to reduce a projecting height.

### (Spring Member 22)

The spring member 22 includes a flat plate portion 52 expanding into a substantially flat plate shape, and this flat plate portion 52 is coupled to the left wall portion 30 in the terminal connecting portion 14 via a curved portion 54 curved into a substantially arcuate shape. These flat plate portion 52 and curved portion 54 are substantially strip-like parts having a substantially constant width (vertical dimension). The curved portion 54 is connected to a front end part, which is a tip part, of the terminal connecting portion 14 and curved to be folded rearward while projecting leftward, and the flat plate portion 52 projects rearward, i.e. toward a base end side, from the rear end of the curved portion 54. In this way, the flat plate portion 52 in the spring member 22 is separated in the lateral direction from the left wall portion 30 in the terminal connecting portion 14, and the curved portion 54 is resiliently deformed to make the flat plate portion 52 displaceable in a direction toward or away from the left wall portion 30. That is, in the first embodiment, a holding portion for holding the spring member 22 in the terminal connecting portion 14 is constituted by the left wall portion 30, which is one of the pair of facing wall portions. Further, a pressing portion 56 slightly curved and projecting leftward, i.e. in the direction away from the left wall portion 30 is provided in an intermediate part in a length direction of the flat plate portion 52 (front-rear direction).

Note that the spring member 22 before being assembled with the housing 18 is shown by two-dot chain line in FIG. 3. As shown in FIG. 3, in a state before being assembled with the housing 18, the flat plate portion 52 is oblique to the holding portion (left wall portion 30), and the left wall portion 30 extends in the front-rear direction, whereas the flat plate portion 52 is inclined leftward toward a rear side. As described later, by assembling the terminal fitting 16 with the housing 18, the pressing portion 56 in the spring member 22 is pressed against the inner surface of a left wall portion 66b in the housing 18 and the flat plate portion 52 in the spring member 22 is resiliently deformed rightward, i.e. in a direction toward the left wall portion 30 (terminal connecting portion 14).

Specifically, a maximum lateral distance (i.e. a lateral distance between the contact surface 34, which is the outer surface of the right wall portion 32, and the projecting tip surface of the pressing portion 56 before being resiliently deformed) A (see FIG. 3) of the terminal fitting 16 before being assembled with the housing 18 is larger than a lateral facing distance between the inner surface (connecting portion side contact surface 92) of the heat dissipation member 24 and the inner surface of the left wall portion 66b in the housing 18. More particularly, the inner surface of the left wall portion 66b in the housing 18 is an inclined surface gradually inclined rightward toward a front side, and a minimum inter-surface distance B (see FIG. 3) between the inner surface of the heat dissipation member 24 and the inner surface of the left wall portion 66b is smaller than the maximum lateral distance A of the terminal fitting 16. In contrast, a maximum inter-surface distance C (see FIG. 3) between the inner surface of the heat dissipation member 24 and the inner surface of the left wall portion 66b is larger than the maximum lateral distance A of the terminal fitting 16.

That is, as described later, when the terminal fitting 16 is inserted into the housing 18 and a space inside the heat dissipation member 24, the projecting tip surface of the pressing portion 56 does not contact the inner surface of the left wall portion 66b at first, and the terminal fitting 16 is inserted without being accompanied by the resilient deformation of the spring member 22. However, at a certain point of time (point of time at which the inter-surface distance between the inner surface of the heat dissipation member 24 and that of the left wall portion 66b is A), the projecting tip surface of the pressing portion 56 and the inner surface of the left wall portion 66b come into contact. Thereafter, by further inserting the terminal fitting 16 into the housing 18 and the space inside the heat dissipation member 22, the pressing portion 56 is pressed against the inner surface of the left wall portion 66b and the terminal fitting 16 is inserted while the spring member 22 is resiliently deformed in the direction toward the terminal connecting portion 14. In an assembled state of the shield connector 10, the pressing portion 56 is pressed against the inner surface of the left wall portion 66b by a resilient restoring force of the spring member 22, and the outer surface (contact surface 34) of the right wall portion 32 in the terminal connecting portion 14 is pressed against the inner surface (connecting portion side contact surface 92 to be described later) of the heat dissipation member 24 by a reaction force.

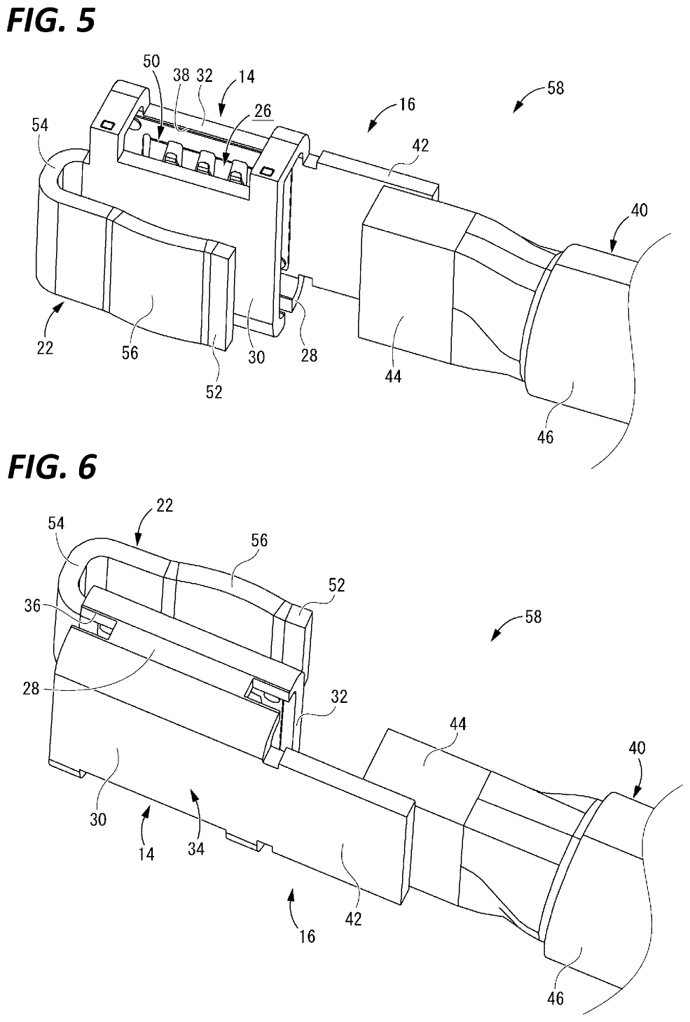

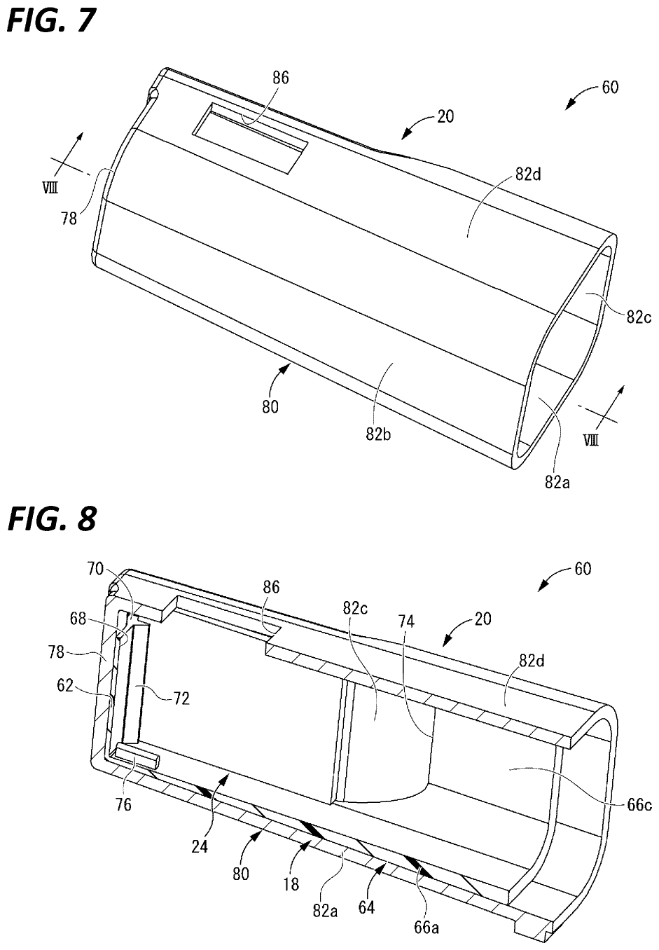

A terminal side assembly 58 is configured as shown in FIGS. 5 and 6 by fixing the wire 40 having the waterproof rubber 48 mounted thereon to the wire connecting portion 42, which is the rear end part of the terminal fitting 16 thus shaped, and fixing each terminal spring portion 50 to the inner surface of the terminal connecting portion 14, which is the front part of the terminal fitting 16. Note that the waterproof rubber 48 is not shown in FIGS. 5 and 6. This terminal side assembly 58 is assembled with a shell side assembly 60 shown in FIGS. 7 and 8. The shell side assembly 60 is configured to include the housing 18, the shield shell 20 and the heat dissipation member 24. Each member constituting the shell side assembly 60 is described below.

### (Housing 18)

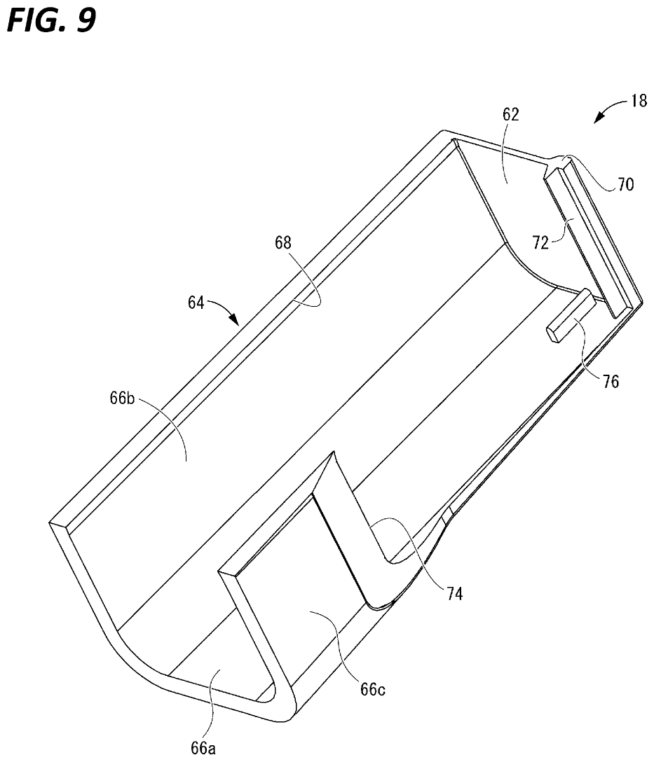

As also shown in FIG. 9, the housing 18 can be understood to have a substantially bottomed tube shape open rearward or a groove shape having a substantially U-shaped cross-section extending in the front-rear direction as a whole, and is made of insulating synthetic resin. Note that, although a method for forming the housing 18 is not limited, the housing 18 is molded, formed separately from the shield shell 20 and assembled later in this embodiment.

If the housing 18 is assumed to have the substantially bottomed tube shape, a substantially rectangular front wall portion 62 corresponding to a bottom wall is provided in a front end part and a peripheral wall portion 64 projecting rearward from a peripheral edge part on three sides except an upper side in the front wall portion 62. Accordingly, the peripheral wall portion 64 includes a lower wall portion 66a on a lower side and left and right wall portions 66b, 66c on both left and right sides. Further, the housing 18 can be understood such that the groove-shaped peripheral wall portion 64 composed of the lower wall portion 66a and the left and right wall portions 66b, 66c and having a substantially U-shaped cross-section extends in the front-rear direction, and a front opening in the groove-shaped peripheral wall portion 64 is closed by the front wall portion 62. Therefore, the groove-shaped peripheral wall portion 64 includes an upper opening 68.

Note that the outer shape of the housing 18 varies in the front-rear direction. Specifically, a front end part (front wall portion 62) of the housing 18 has a substantially vertically long rectangular shape having a vertical dimension larger than a lateral dimension, and the right wall portion 66c is provided with a part inclined gradually rightward toward a rear side in an intermediate part in the front-rear direction, whereby a rear end part of the peripheral wall portion 64 has a substantially square shape. That is, an internal space of the housing 18 is larger in a rear part than in a front part.

Further, a front protrusion 70 projecting forward is provided on a right end part of the front wall portion 62. At the formation position of this front protrusion 70, a supporting protrusion 72 projecting rearward from the rear surface of the front wall portion 62 is provided on a laterally inner side (left side) of the right end part of the front wall portion 62. The right wall portion 66c is formed with an opening window 74 cut from a front end part to an intermediate part in the front-rear direction. Specifically, a front end part of the opening window 74 is located substantially at the same position as the rear surface of the front wall portion 62, and a rear end part of the opening window 74 is located at a middle position of the part of the right wall portion 66c inclined rightward toward the rear side. Also through this opening window 74, the internal space of the housing 18 and the outside space communicate with each other. Further, a positioning protrusion 76 having a predetermined dimension in the front-rear direction is provided in a lateral central part in a front end part of the lower wall portion 66a.

### (Shield Shell 20)

The shield shell 20 is made of metal excellent in heat dissipation. The shield shell 20 has a substantially bottomed tube shape open rearward as a whole. That is, the shield shell 20 includes a substantially rectangular front end wall portion 78 and a tubular wall portion 80 projects rearward from a peripheral edge part on four sides of the front end wall portion 78. Therefore, the tubular wall portion 80 includes a lower end wall portion 82a on a lower side, left and right end wall portions 82b, 82c on both left and right sides and an upper end wall portion 82d on an upper side and.

The shield shell 20 is formed in a size capable of accommodating the housing 18. When the housing 18 is accommodated into the shield shell 20, the inner surface of the shield shell 20 and the outer surface of the housing 18 are substantially in close contact. That is, the outer shape of the shield shell 20 and the outer shape of the housing 18 are substantially equal. Specifically, a front end part (front end wall portion 78) of the shield shell 20 has a substantially vertically long rectangular shape, and a part inclined gradually rightward toward the rear side is provided in an intermediate part in the front-rear direction of the right end wall portion 82c, whereby a rear end part of the shield shell 20 has a substantially square outer shape. Further, a right end part of the front end wall portion 78 is provided with an accommodation recess 84, into which the front protrusion 70 of the housing 18 is accommodated and which is open rearward.

Further, a front part of the upper end wall portion 82d of the shield shell 20 is formed with the mating terminal insertion hole 86 penetrating in a thickness direction (vertical direction), and an internal space of the shield shell 20 and the outside space communicate with each other through the mating terminal insertion hole 86. Further, the housing 18 to be accommodated into the shield shell 20 is provided with the upper opening 68 and an upper part of the housing 18 is substantially entirely open. Thus, an internal space of the shell side assembly 60 and the outside space communicate with each other through these mating terminal insertion hole 86 and upper opening 68.

The waterproof rubber 48 externally fit to the wire 40 is substantially press-fit into the internal space in the rear end part of the shield shell 20, and a retainer 88 for preventing the detachment of the waterproof rubber 48 from the shield shell 20 is provided in a rear end part of the shield shell 20. In the first embodiment, the retainer 88 is vertical divisible and composed of an upper retainer 90 and a lower retainer 90b. The upper and lower retainers 90a, 90b cover the rear end part of the shield shell 20 from upper and lower outer sides, and the retainer 88 is assembled with the rear end part of the shield shell 20 by being fixed by unillustrated bolts or the like. Note that positioning protrusions projecting vertically upward and downward may be provided on the rear end part of the shield shell 20 and the upper and lower retainers 90a, 90b may be provided with positioning holes corresponding to these positioning protrusions. In this way, the shield shell 20 and the upper and lower retainers 90a, 90b may be positionally aligned with each other by inserting the positioning protrusions into the positioning holes when the upper and lower retainers 90a, 90b are assembled with the rear end part of the shield shell 20.

### (Heat Dissipation Member 24)

The shape and material of the heat dissipation member 24 are not limited if the heat dissipation member 24 has an insulating property, but the heat dissipation member 24 has a substantially flat plate shape in this embodiment. Further, the heat dissipation member 24 only has to have a larger thermal conductivity than air, but is preferably excellent in thermal conductivity. In this embodiment, the heat dissipation member 24 is made of ceramic excellent in thermal conductivity. This heat dissipation member 24 is assembled to cover a front part of the opening window 74 in the housing 18 accommodated in the shield shell 20. Particularly, when being assembled, the heat dissipation member 24 is inserted between the supporting protrusion 72 and the right end wall portion 82c of the shield shell 20 facing each other in the lateral direction, and the front end position of the heat dissipation member 24 is specified by the contact of the heat dissipation member 24 with the front wall portion 62 in the housing 18.

When the shield connector 10 is assembled, one surface (left end surface in the first embodiment) in a plate thickness direction of the heat dissipation member 24 contacts the contact surface 34, which is the outer surface of the right wall portion 32 in the terminal connecting portion 14. As a result, the connecting portion side contact surface 92 to be held in contact with the contact surface 34 is formed by one surface in the plate thickness direction of the heat transfer portion (heat dissipation member 24). Further, the other surface (right end surface in the first embodiment) in the plate thickness direction of the heat dissipation member 24 is exposed on the outer surface of the housing 18 through the opening window 74 of the housing 18 and contacts the shield shell 20 covering the outer surface of the housing 18. In this way, a shell side contact surface 94 is formed by the other surface in the plate thickness direction of the heat dissipation member 24. Particularly, in the first embodiment, the shell side contact surface 94 of the heat dissipation member 24 is entirely in contact with the inner surface of the right end wall portion 82c of the shield shell 20.

### (Assembly Process of Shield Connector 10)

Next, a specific example of an assembly process of the shield connector 10 is described. Note that the assembly process of the shield connector 10 is not limited to that described below.

First, the metal flat plate having a specific shape and fixed to the terminal spring portions 50 is, for example, bent to form the terminal fitting 16 integrally including the terminal connecting portion 14 and the spring member 22. Thereafter, the wire 40 is fixed to the wire connecting portion 42 of the terminal fitting 16 and the waterproof rubber 48 is externally fit to the wire 40, whereby the terminal side assembly 58 is completed. Note that the waterproof rubber 48 may be mounted on the wire 40 before the wire 40 is fixed to the wire connecting portion 42 and can be mounted on the wire 40 at an arbitrary timing.

Further, the shield shell 20, the housing 18 and the heat dissipation member 24 are respectively separately formed and prepared. Thereafter, the housing 18 is inserted through a rear opening of the shield shell 20 and accommodated into the shield shell 20. Subsequently, the heat dissipation member 24 is inserted through the rear opening of the housing 18 and inserted between the right end wall portion 82c of the shield shell 20 and the supporting protrusion 72 of the housing 18 through the opening window 74, and a front end part of the heat dissipation member 24 is brought into contact with the front wall portion 62 of the housing 18. In this way, the shell side contact surface 94 of the heat dissipation member 24 is exposed on the outer surface of the housing 18 through the opening window 74 and brought into contact with the inner surface of the right end wall portion 82c of the shield shell 20. As a result, the shell side assembly 60 is completed.

Thereafter, the completed terminal side assembly 58 and shell side assembly 60 are opposed to each other in the front-rear direction, and the terminal side assembly 58 is inserted into the internal space of the shell side assembly 60. In this way, at a certain point of time, the projecting tip surface of the pressing portion 56 in the spring member 22 comes into contact with the inner surface of the left wall portion 66b in the housing 18 and, thereafter, the terminal side assembly 58 is inserted into the shell side assembly 60 as the spring member 22 (flat plate portion 52) is resiliently deformed toward the terminal connecting portion 14. The insertion of the terminal side assembly 58 into the shell side assembly 60 is guided by inserting the positioning protrusion 76 provided on the lower wall portion 66a of the housing 18 into the positioning recess 36 provided in the lower wall portion 28 of the terminal connecting portion 14. Further, the insertion of the terminal side assembly 58 into the shell side assembly 60 is limited, for example, by the contact of the front end surface of the curved portion 54 in the terminal fitting 16 with the rear end surface of the front wall portion 62 in the housing 18. In this insertion completed state, the pressing portion 56 in the spring member 22 is pressed against the left wall portion 66b in the housing 18, and the outer surface (contact surface 34) of the right wall portion 32 in the terminal connecting portion 14 is constantly pressed against the connecting portion side contact surface 92 of the heat dissipation member 24 by a reaction force.

As the terminal side assembly 58 is inserted into the shell side assembly 60, the waterproof rubber 48 is press-fit into the rear opening of the shield shell 20 to seal the rear opening of the shield shell 20 in a liquid-tight manner. Thereafter, the upper and lower retainers 90a, 90b are overlaid on the rear end part of the shield shell 20 from both upper and lower sides to fix the retainer 88, whereby the shield connector 10 is completed. In a completed state of the shield connector 10, the upper opening 38 in the terminal connecting portion 14 and the mating terminal insertion hole 86 in the shield shell 20 are provided at positions overlapping each other in the vertical direction and the internal space (mating terminal arrangement portion 26) of the terminal connecting portion 14 communicates with the outside space through the upper opening 38 and the upper opening 68 and the mating terminal insertion hole 86 in the housing 18.

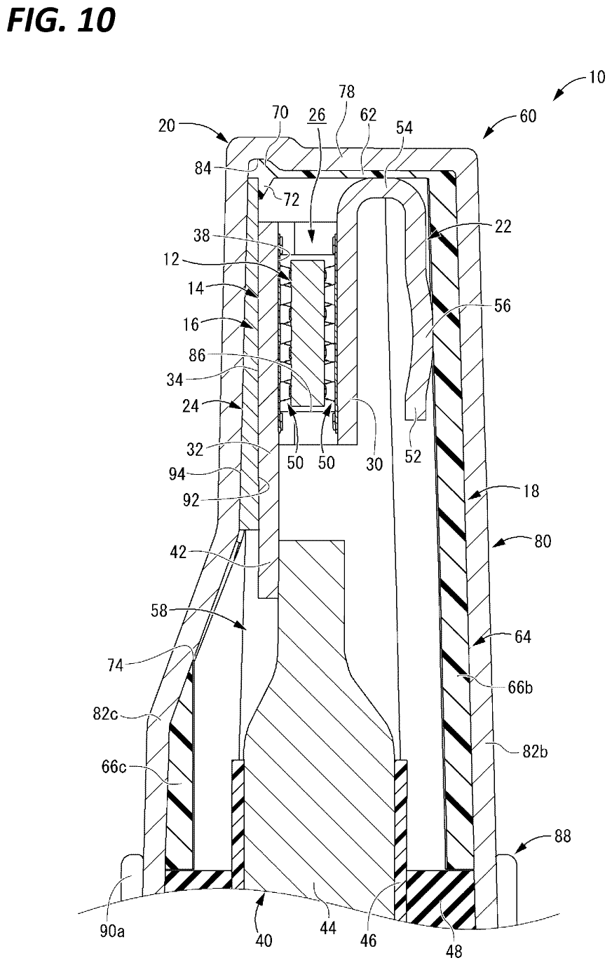

In the shield connector 10 assembled in this way, the mating terminal 12 is inserted from above through the mating terminal insertion hole 86 and the respective upper openings 38, 68 and arranged in the mating terminal arrangement portion 26, which is the internal space of the terminal connecting portion 14, as shown in FIG. 10, whereby the terminal spring portions 50 are pushed and resiliently deformed between the terminal connecting portion 14 and the mating terminal 12. In this way, the terminal connecting portion 14 and the mating terminal 12 contact and are electrically connected via the terminal spring portions 50.

Further, as described above, the pressing portion 56 in the spring member 22 is pressed against the left wall portion 66b in the housing 18 and the flat plate portion 52 is resiliently deformed toward the terminal connecting portion 14. The pressing portion 56 is biased toward the left wall portion 66b by a resilient restoring force of this flat plate portion 52, the outer surface (contact surface 34) of the right wall portion 32 in the terminal connecting portion 14 is pressed against the connecting portion side contact surface 92 of the heat dissipation member 24 by a reaction force against this biasing force, and the shell side contact surface 94 of the heat dissipation member 24 is pressed against the inner surface of the right end wall portion 82c in the shield shell 20. In short, the terminal connecting portion 14 is pressed into contact with the shield shell 20 via the heat transfer portion (heat dissipation member 24) by a resilient force (restoring force) of the spring member 22.

Further, when the mating terminal 12 is inserted into the mating terminal arrangement portion 26, the terminal spring portions 50 are resiliently deformed between the mating terminal 12 and the terminal connecting portion 14, the contact surface 34 of the right wall portion 32 in the terminal connecting portion 14 is pressed against the connecting portion side contact surface 92 of the heat dissipation member 24 also by this resilient restoring force and, consequently, the shell side contact surface 94 of the heat dissipation member 24 is pressed against the inner surface of the right end wall portion 82c in the shield shell 20. As a result, the right wall portion 32 in the terminal connecting portion 14 and the heat dissipation member 24, and the heat dissipation member 24 and the shield shell 20 are respectively held in close contact, and heat generated due to energization between the terminal connecting portion 14 and the mating terminal 12 is transferred to the shield shell 20 via the heat dissipation member 24 and dissipated to outside from the shield shell 20.

Further, since the wire connecting portion 42 to be fixed to the core wire 44 of the wire 40 is provided in the rear end part of the terminal fitting 16 in the first embodiment, not only heat generated in a contact point portion between the terminal connecting portion 14 and the mating terminal 12, but also heat generated in a connected part of the wire connecting portion 42 and the core wire 44 can be dissipated via the heat dissipation member 24. That is, in addition to heat generated between the terminal connecting portion 14 and the mating terminal 12, heat generated in the connected part of the wire connecting portion 42 having a relatively large heat generation amount and the core wire 44 is dissipated via the heat dissipation member 24 and the shield shell 20. Therefore, good heat dissipation is exhibited.

In the shield connector 10 of the first embodiment, the terminal fitting 16 integrally including the spring member 22 is adopted, and the terminal connecting portion 14 is pressed against the heat transfer portion (heat dissipation member 24) and the pressed heat transfer portion (heat dissipation member 24) is further pressed against the shield shell 20 by a resilient restoring force associated with the resilient deformation of the spring member 22 with the terminal fitting 16 accommodated in the housing 18. In this way, in the assembled state of the shield connector 10, the terminal connecting portion 14 and the heat transfer portion (heat dissipation member 24), and the heat transfer portion (heat dissipation member 24) and the shield shell 20 are constantly held in close contact, a heat dissipation path from the heat generating part due to energization between the terminal connecting portion 14 and the mating terminal 12 to outside via the heat transfer portion (heat dissipation member 24) and the shield shell 20 can be made shorter, and heat dissipation efficiency is improved.

Further, for example, when an ambient temperature largely changes, there has been a possibility of forming a gap (air layer) between members made of different materials due to a difference in linear expansion coefficient in the conventional structure. However, since the terminal connecting portion 14 and the heat transfer portion (heat dissipation member 24), and the heat transfer portion (heat dissipation member 24) and the shield shell 20 are constantly held in close contact in the shield connector 10 of the first embodiment, the formation of gaps between the terminal connecting portion 14 and the heat transfer portion (heat dissipation member 24) and between the heat transfer portion (heat dissipation member 24) and the shield shell 20 is suppressed and a reduction in heat dissipation performance is prevented also when the ambient temperature largely changes. Particularly, since the spring member 22 contributing to such close contact between the terminal connecting portion 14 and the heat transfer portion (heat dissipation member 24) and between the heat transfer portion (heat dissipation member 24) and the shield shell 20 is integrally provided to the terminal fitting 16, effects of reducing the number of components and improving assembly workability are achieved.

Particularly, since the heat transfer portion is configured to include the heat dissipation member 24 having a higher thermal conductivity than the housing 18 in the first embodiment, good heat dissipation performance is exhibited. Further, since the shell side contact surface 94 in the heat dissipation member 24 is entirely in contact with the inner surface of the right end wall portion 82c in the shield shell 20 in the first embodiment, more efficient heat dissipation can be realized.

The terminal connecting portion 14 has the rectangular tube shape and the inside thereof serves as the mating terminal arrangement portion 26, into which the mating terminal 12 is inserted. Thus, even if the terminal spring portions 50 for more reliable contact with the mating terminal 12 are provided inside the terminal connecting portion 14, the contact of the terminal spring portions 50 with another member or the like inside the shell side assembly 60 is avoided in inserting the terminal side assembly 58 into the shell side assembly 60 and the terminal spring portions 50 are prevented from being deformed before the insertion of the mating terminal 12. Further, in the terminal connecting portion 14 having the rectangular tube shape, the holding portion for holding the spring member 22 is formed by the left wall portion 30, which is one facing wall portion, and the contact surface 34 to be held in contact with the heat dissipation member 22 is provided on the right wall portion 32, which is the other facing wall portion. In this way, in the terminal connecting portion 14, a part for holding the spring member 22 and a part to be held in contact with the heat dissipation member 24 can be separately provided, and the left and right wall portions 30, 32 can be shaped suitable for the respective functions. Therefore, effects of improving the function of holding the spring member 22, heat dissipation efficiency by the heat dissipation member 24 and the like are exhibited.

The spring member 22 includes the flat plate portion 52, and the flat plate portion 52 is coupled to the holding portion (left wall portion 30) in the terminal connecting portion 14 via the curved portion 54. By adopting such a structure, the resilient deformation of the spring member 22 is easily realized by the bending deformation of the curved portion 54, and the pressing of the pressing portion 56 against the inner surface of the housing 18 and, consequently, the pressing of the terminal connecting portion 14 against the heat dissipation member 24 can be easily realized.

### Second Embodiment

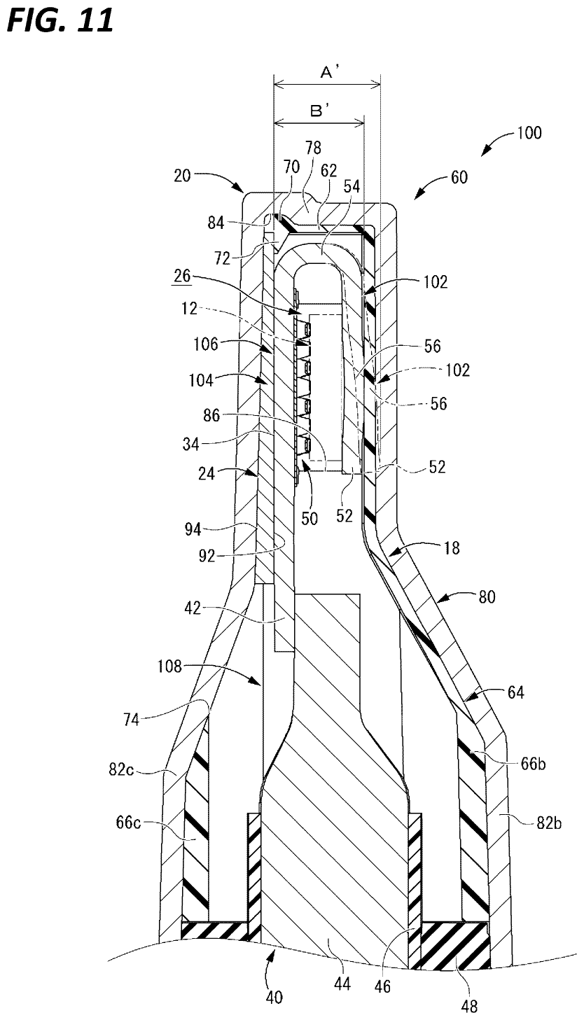

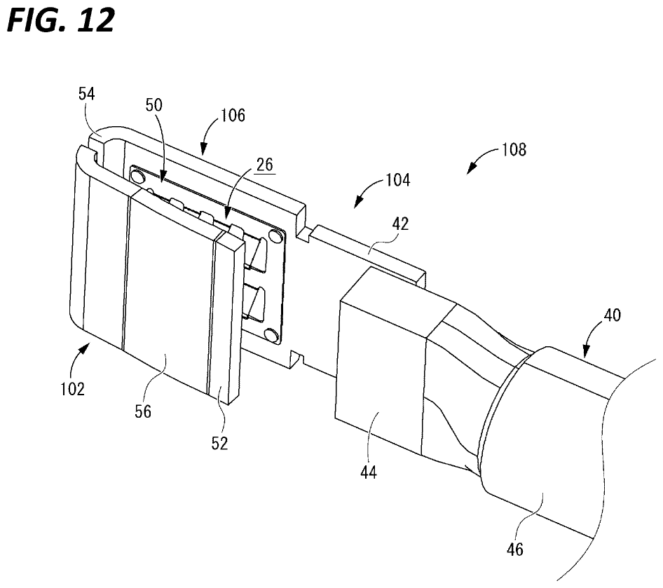

Next, a shield connector 100 of a second embodiment of the present disclosure is described with reference to FIGS. 11 and 12. Note that a basic structure of the shield connector 100 of the second embodiment is similar to that of the shield connector 10 of the first embodiment and differs only in the structure of a terminal fitting 104 integrally including a spring member 102. Note that, in the following description, substantially the same members and parts as those of the first embodiment are denoted by the same reference signs as in the first embodiment in figures and not described in detail.

### (Terminal Fitting 104)

In the second embodiment, a terminal connecting portion 106 in the terminal fitting 104 has a flat plate shape extending in the front-rear direction. One surface (right end surface) in a plate thickness direction (lateral direction) of the terminal connecting portion 106 is a contact surface 34 to be held in contact with a connecting portion side contact surface 92 in a heat dissipation member 24. Further, the other surface (left end surface) in the plate thickness direction of the terminal connecting portion 106 having the flat plate shape contacts a mating terminal 12 arranged in a mating terminal arrangement portion 26, and a terminal spring portion 50 is provided on the left end surface of the terminal connecting portion 106. Note that the mating terminal 12 to be arranged in the mating terminal arrangement portion 26 is shown by two-dot chain line in FIG. 11.

### (Spring Member 102)

The spring member 102 in the second embodiment also includes a flat plate portion 52 expanding into a substantially flat plate shape, and this flat plate portion 52 is coupled to a front end part, which is a tip part, of the terminal connecting portion 106 via a curved portion 54. That is, the curved portion 54 is connected to the front end part of the terminal connecting portion 106 and curved to be folded rearward while projecting leftward, and the flat plate portion 52 projects rearward toward a base end side from the rear end of the curved portion 54. In this way, the flat plate portion 52 is made displaceable in a direction toward or away from the terminal connecting portion 106 by the bending deformation of the curved portion 54. Further, a pressing portion 56 is provided in an intermediate part in a length direction of the flat plate portion 52.

Note that the spring member 102 before being assembled with a housing 18 is shown by two-dot chain line in FIG. 11. As shown in FIG. 11, in a state before being assembled with the housing 18, the flat plate portion 52 is oblique to the terminal connecting portion 106 and inclined leftward toward a rear side. A terminal side assembly 108 configured by fixing a wire 40 to a wire connecting portion 42 in the terminal fitting 104 including the spring member 106 having such a shape is shown in FIG. 12.

Also in the second embodiment, a maximum lateral distance (i.e. a lateral distance between the contact surface 34, which is the outer surface of the terminal connecting portion 106, and a projecting end part (rear end part) of the flat plate portion 52 before being resiliently deformed) A′ (see FIG. 11) of the terminal fitting 104 before being assembled with the housing 18 is larger than a lateral facing distance B′ (see FIG. 11) between the inner surface (connecting portion side contact surface 92) of the heat dissipation member 24 and the inner surface of a left wall portion 66b in the housing 18. In this way, when the terminal fitting 104 is inserted into the housing 18 in the second embodiment, the projecting tip surface of the pressing portion 56 located in the intermediate part in the length direction of the flat plate portion 52 and the inner surface of the left wall portion 66b also come into contact and, thereafter, the terminal fitting 104 is inserted into the shell side assembly 60 while the spring member 102 is resiliently deformed in the direction toward the terminal connecting portion 106. By a resilient restoring force of this spring member 102, the pressing portion 56 is pressed against the inner surface of the left wall portion 66b and the outer surface (contact surface 34) of the terminal connecting portion 106 is pressed against the inner surface (connecting portion side contact surface 92) of the heat dissipation member 24 by a reaction force.

Therefore, also in the shield connector 100 structured as in the second embodiment, effects similar to those of the first embodiment can be exhibited. Particularly, since the terminal connecting portion 106 has a simple flat plate shape in the second embodiment, a lateral dimension of the terminal fitting 104 can be suppressed to be small, with the result that a front end part of the shield connector 100 can also be reduced in size.

### Other Embodiments

The technique described in this specification is not limited by the above described and illustrated embodiments. For example, the following embodiments are also included in the technical scope of the technique described in this specification.

(1) Although the heat transfer portion is constituted by the heat dissipation member 24 in the above embodiments, the heat transfer portion may be, for example, constituted by the housing and the terminal connecting portion may directly contact the housing. In this way, heat generated due to energization between the mating terminal and the terminal connecting portion can be dissipated to outside via the housing and the shield shell.

(2) Although the spring member 22, 102 is formed by bending a substantially strip-like metal flat plate and integrally formed to the terminal fitting 16, 104 in the above embodiments, a spring member may be, for example, a coil spring, formed separately from a terminal fitting and integrally provided to the terminal fitting, such as by being fixed to the outer surface of a left wall portion of the terminal fitting later. In this case, the coil spring may be, for example, arranged in a compressed state between the outer surface of the left wall portion of the terminal fitting and the inner surface of a left wall portion in the housing, and a terminal connecting portion may be pressed into contact with a shield shell via a heat transfer portion (heat dissipation member) by a resilient restoring force of the coil spring.

(3) Although the heat dissipation member 24 has a substantially flat plate shape and is made of ceramic in the above embodiments, there is no limitation to this if the heat dissipation member has an insulating property. If the heat dissipation member is provided as the heat transfer portion, the heat dissipation member can be made of synthetic resin having a larger thermal conductivity than air, besides ceramic, but preferably has a larger thermal conductivity than the synthetic resin constituting the housing. Specifically, silicone-based resins, non-silicone-based acrylic resins, ceramic-based resins and the like can be used. More particularly, a heat dissipation sheet, a heat dissipation gap filler, a thermally conductive grease, a thermally conductive silicone rubber and the like made of silicone-based resin can be used. Further, although the terminal connecting portion 14 is directly in contact with the heat dissipation member 24 and the heat dissipation member 24 is directly in contact with the shield shell 20 in the above embodiments, a heat dissipation sheet, a heat dissipation gap filler, a thermally conductive grease or the like as described above may be interposed between these members.

### LIST OF REFERENCE NUMERALS

10 shield connector (first embodiment)
12 mating terminal
14 terminal connecting portion
16 terminal fitting
18 housing
20 shield shell
22 spring member
24 heat dissipation member (heat transfer portion)
26 mating terminal arrangement portion
28 lower wall portion
30 left wall portion (one of pair of facing wall portions, holding portion)
32 right wall portion (other of pair of facing wall portion)
34 contact surface
36 positioning recess
38 upper opening
40 wire
42 wire connecting portion
44 core wire
46 insulation coating
48 waterproof rubber
50 terminal spring portion
52 flat plate portion
54 curved portion
56 pressing portion
58 terminal side assembly
60 shell side assembly
62 front wall portion
64 peripheral wall portion
66a lower wall portion
66b left wall portion
66c right wall portion
68 upper opening
70 front protrusion
72 supporting protrusion
74 opening window
76 positioning protrusion
78 front end wall portion
80 tubular wall portion
82a lower end wall portion
82b left end wall portion
82c right end wall portion
82d upper end wall portion
84 accommodation recess
86 mating terminal insertion hole
88 retainer
90a upper retainer
90b lower retainer
92 connecting portion side contact surface
94 shell side contact surface
100 shield connector (second embodiment)
102 spring member
104 terminal fitting
106 terminal connecting portion
108 terminal side assembly

1. A shield connector, comprising:
a terminal fitting including a terminal connecting portion to be connected to a mating terminal;
an insulating housing for accommodating the terminal fitting;
a shield shell for covering an outer surface of the housing;
a heat transfer portion for transferring heat of the terminal connecting portion to the shield shell by being interposed between the terminal connecting portion and the shield shell; and
a spring member integrally provided to the terminal fitting,
the terminal connecting portion being pressed into contact with the shield shell via the heat transfer portion by a resilient force of the spring member.

2. The shield connector of claim 1, wherein:
the heat transfer portion includes a heat dissipation member made of an insulating material having a higher thermal conductivity than the housing, and
the heat dissipation member has a connecting portion side contact surface to be held in contact with the terminal connecting portion and a shell side contact surface to be held in contact with the shield shell by being exposed from the housing.

3. The shield connector of claim 1, wherein:
the terminal connecting portion of the terminal fitting has a rectangular tube shape,
a mating terminal arrangement portion is formed inside the terminal connecting portion, the mating terminal being inserted into the mating terminal arrangement portion, and
a holding portion for holding the integrally provided spring member is formed by one of a pair of facing wall portions of the terminal connecting portion, a contact surface is formed by the other of the pair of facing wall portions, and the contact surface is pressed into contact with the heat transfer portion.

4. The shield connector of claim 3, wherein:
the spring member is constituted by a flat plate portion separated and inclined from the holding portion and projecting toward a base end side of the terminal connecting portion via a curved portion provided on a tip part of the holding portion of the terminal connecting portion, and
the spring member is resiliently deformed in a direction toward the terminal connecting portion with the terminal fitting accommodated in the housing.

5. The shield connector of claim 1, wherein:
the terminal connecting portion of the terminal fitting has a flat plate shape,
the spring member is constituted by a flat plate portion separated and inclined from the terminal connecting portion and projecting toward a base end side of the terminal connecting portion via a curved portion provided on a tip part of the terminal connecting portion, and
the spring member is resiliently deformed in a direction toward the terminal connecting portion with the terminal fitting accommodated in the housing.
